(19) United States
(12) Patent Application Publication
(10) Pub. No.: US 2003/0065614 A1
(43) Pub. Date: Apr. 3, 2003

(54) Method and system for rules based underwriting

(76) Inventor: Joan M. Sweeney, Oakton, VA (US)

Correspondence Address: Mark Ungerman, Fulbright & Jaworski, L.L.P., 801 Pennsylvania Avenue, N.W., Washington, DC, 20004, US

(21) Appl. No.: 09/966,268

(22) Filed: Oct. 1, 2001

(51) Int. Cl. G06F 17/60

(52) U.S. Cl. 705/38

(57) ABSTRACT

A business loan applicant may enter a secured site, input information into a simplified loan application and receive an automated, non-binding term sheet based on a parameter driven credit matrix and applicable loan product. An underwriter's web site may provide an applicant with web pages for a multi-screen loan application. After the application is submitted, the underwriter may use a credit matrix application to automate credit decisions, which eliminates or minimizes human interaction. After the credit matrix determines a credit score, it may be sent to a loan product identifier to determine the loan product an applicant may be eligible to receive. Once the loan product is identified, a term sheet generator may send the results to the applicant using the underwriter's web pages.

### BACKGROUND OF THE INVENTION

1. Technical Field

The invention relates generally to an underwriting system including an apparatus and method, and in particular, to an on-line system for rules based underwriting. The apparatus and method may be particularly suited for small businesses and may determine a business' eligibility to receive a loan product by evaluating credit, collateral, and/or business experience.

2. Background Art

One method for evaluating loan applications may use an Internet based manually driven process. An applicant may complete a brief preliminary questionnaire on-line. Upon submission, completed data forms may be e-mailed or faxed to a business development officer (BDO). The BDO may review and perform an analysis on the information and determine if the applicant is eligible for a loan. If the applicant does not meet the underwriter's requirements, a letter or e-mail declining the loan application is sent to the applicant. If the applicant initially meets the credit requirements, the BDO may contact the applicant. Contacting the applicant may occur within 24-48 hours. The BDO may perform additional screening of the loan opportunity to further determine basic eligibility, collateral type, management experience, and cash flow availability. The applicant may also fax the BDO a business tax return and permission to obtain a personal credit report. After the BDO has collected the information, he may determine the applicant's eligibility and generate a term sheet.

If the application meets basic underwriting parameters, the BDO may meet the applicant to continue the loan application process. The BDO may gather any additional information necessary to evaluate creditworthiness and eligibility as well as permission to request a personal credit report (if not obtained previously) and tax return verification. The BDO may then ask the applicant to make a commitment (via a deposit) in order to start the paperwork process to obtain loan approval, issue a commitment letter and ultimately close the loan. If a term sheet had not been prepared prior to the site visit, the BDO may review the additional information collected during the meeting and either prepare a term sheet during or after the visit or issue a decline letter.

The afore described process is inefficient. A BDO may spend a significant amount of non-productive time reviewing loan applications and contacting borrowers on deals that do not fit within lender's parameters. In addition, loan applications that marginally meet the underwriting criteria other require a high amount of time and effort by the BDO throughout the process. Human factors contribute to approval of such marginal applications due to the extended review period and issuance of such loans often results in a less profitable portfolio.

### DISCLOSURE OF THE INVENTION

In an embodiment of the invention, a business loan applicant may access a secured site, input information into a simplified loan application and receive an automated, non-binding term sheet based on a parameter driven credit matrix and applicable loan product identifier.

An object of the present invention is to provide a method and system for a computer application, which implements an on-line underwriting system through a communications network.

Another object of the present invention is to provide a web-based business process that may generate an automated term sheet, which eliminates unnecessary employee interaction.

Another object of the invention is to automate a loan application process, which will increase the number of loans an underwriter is able to process.

An object of the invention is to reduce the average time to close a loan and reduce the total time devoted to process each loan application.

Another object of the invention is to increase the productivity of a BDO. This object may be accomplished by improving the loan application filtering process, which will provide a BDO with better quality prospects.

Another object of the invention is to provide a complete loan application on a lender site and link the site to related financial services and loan aggregation sites to draw increased volumes of potential borrowers to the lender site.

Another object of the invention is to provide a method to capture, document and standardize current business practices throughout the organization.

Another object of the invention is to allow for continual review of criteria and comparison of actual loan performance back to the original credit evaluation. This information may permit the underwriter to update the credit matrix model.

In a preferred embodiment, the method and apparatus rely on in unabridged loan application, which may be able to apply a decision process to the information.

Another object of the present invention is to provide a web-based business process that allows applicants to apply for a loan at any hour and receive a term sheet instantly.

In a preferred embodiment, the apparatus and system may provide an underwriter with the ability to track the progression of loan applications.

In a preferred embodiment, the incentive-based marketing method and system may be implemented over the World Wide Web, Intranet, WAN, LAN or any other communications network.

### BRIEF DESCRIPTION OF THE DRAWINGS

FIG. 1 shows an embodiment of the invention

FIG. 2 shows another embodiment of the invention

FIG. 3 shows another embodiment of the invention

FIG. 4 shows another embodiment of the invention

FIG. 5 shows another embodiment of the invention

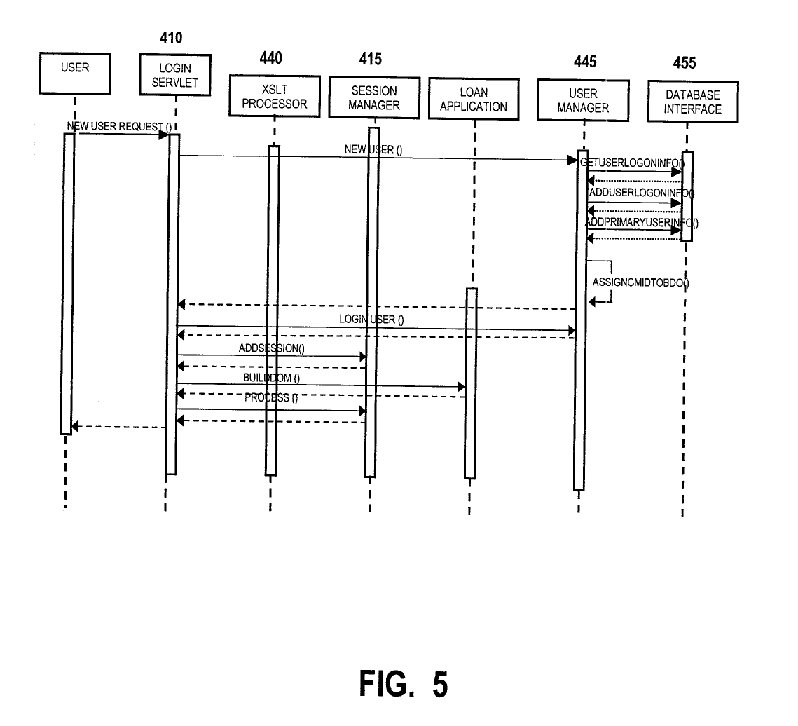

### BEST MODE FOR CARRYING OUT THE INVENTION

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

The present invention may provide a system including an apparatus and method for a computer application, which implements a rules based underwriting process. An underwriter using an embodiment of the invention may automate a small business loan process. The underwriter may also automate a method for identifying loan products for which an applicant may be eligible.

In a preferred embodiment a underwriter's web site may provide an applicant with web pages for a multi-screen loan application. After the application is submitted, the underwriter may use a credit matrix application to automate credit decisions, which eliminates human interaction. After the credit matrix determines a credit score, it may be sent to a loan product identifier to determine the loan product an applicant may be eligible to receive. Once the loan product is identified, a term sheet generator may send the results to the applicant using the underwriter's web pages.

In an embodiment of the invention, the underwriter may leverage programs from the United States Small Business Administration. The underwriter in the preferred embodiment may be an active lender in the Small Business Administration (SBA) Section 7(a) guaranteed loan program and businesses applying for these loans are subject to SBA eligibility requirements. An underwriter's typical applicant may be small business owners, such as, Gas station/Convenience Stores; Hotels/Motels; Restaurants; Day Care Centers; Assisted Living Facilities; Professional Services; Manufacturing; or Retailers.

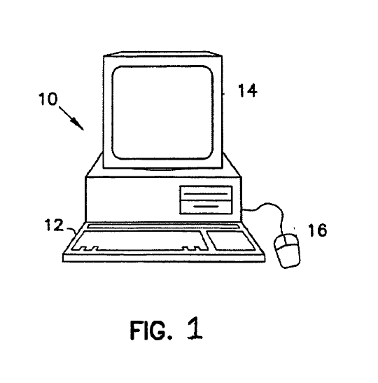

A computer according to an embodiment of the present invention may perform the operations for the computer application, which implements a rules based underwriting process. A computer/computers may be located at the underwriter/service provider site, applicant site and/or Business Development Officer BDO. A typical computer on which the present invention may be implemented is shown in FIG. 1. Computer 10 usually includes keyboard 12, display device 14 and pointing device 16. Computer 10 may include a processor (such as those made by Intel Corporation or Motorola), random-access memory, read-only memory (ROM), and one or more storage devices, such as a hard disk drive, a floppy disk drive, an optical disk drive, and a tape cartridge drive. The invention is not particularly limited to a given type of computer 10. A given computer 10 may be preferably a PC-compatible computer such as those manufactured and available from Gateway 2000, Inc., of North Sioux City, S. Dak., and running a version of the Microsoft Windows operating system. It is contemplated, however, that the present system would work equally well using a MACINTOSH computer or even another operating system such as a UNIX based operating system. The construction and operation of such computers are known within the art.

Monitor 14 of the computer system permits the display of information for viewing by a user of the computer. The invention is not limited to any particular type of monitor 14. Such monitors may include cathode ray tube (CRT) displays, as well as flat panel displays such as liquid crystal displays (LCD's) and super-VGA CRT displays. Each pointing device 16 permits the control of the screen pointer provided by the graphic user interface of operating system. The invention is not limited to any particular type of pointing device 16. Such pointing devices include mouses, touch pads, trackballs, remotes, and point sticks. Keyboard 12 permits textual entry into computer 10 as another input device to the computer, and typically includes a plurality of alphanumeric keys, function keys, navigation keys, cursor keys, and numeric keypad keys. However, the invention is not so particularly limited.

Computer 10 may include a communications software application, a browser, which allows a computer to access another computer over a communications medium/network. The browser may be the Microsoft Internet Explorer, developed by Microsoft Corporation. One of ordinary skill in the art, however, will recognize that numerous other types of communications software applications may also be used to implement the present invention. Such communications software could, for example, be other types of Internet browsers such as the Netscape Navigator developed by Netscape, Inc., and other communications software such as custom network browsers, two-way communications software, cable modem software, point-to-point software and the like.

The computer 10 may be a workstation, desktop computer, laptop computer, mobile computer, PDA, server, client, peer, multiprocessor machine, and/or other computer. A suitable communication networks include local area networks, metropolitan area networks, wide area networks, the Internet, or any combination thereof. “Internet” as used herein includes variations such as a private Internet, a secure Internet, a value-added network, a virtual private network, a portion of the Internet such as the World Wide Web, or an intranet. If an Internet connection is used, some security precautions may be taken in an embodiment of the invention. For example, secure servers or encryption methods may be used.

Various possible types of communication links may be employed for the communication links between the service provider, brokers and the independent contractors. For example, the communication link may comprise a hard wired connection, a telephone connection, a satellite RF, or other wireless connection, an Internet connection, a local area network or wide area network connection, a combination of the preceding, or any other desired type of connection. Different machines can connect using different types of communication links.

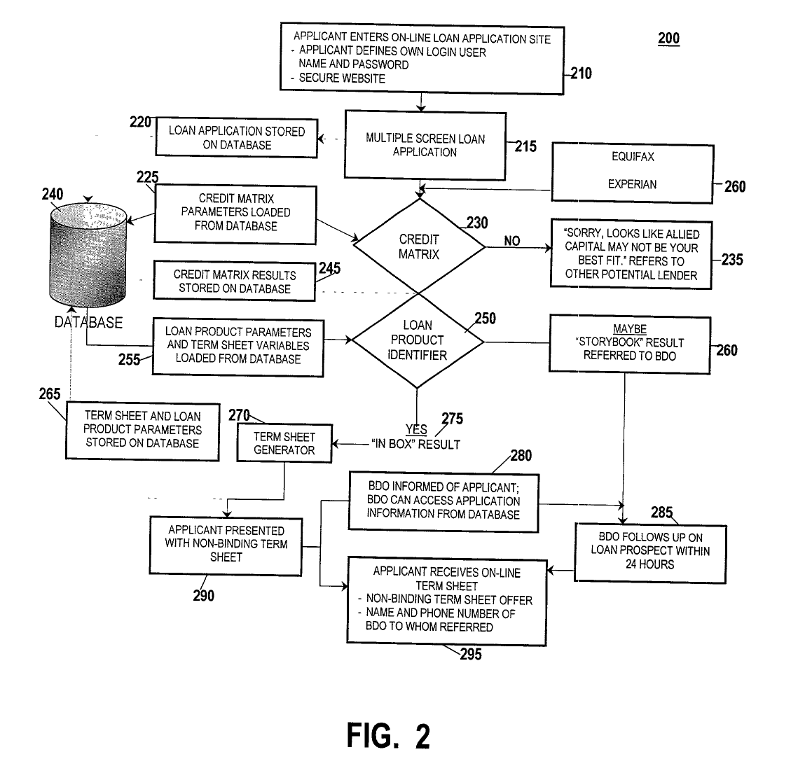

FIG. 2 shows an embodiment of the present invention, an applicant may be connected through a communications network to the lender (a.k.a. underwriter/server provider). In the preferred embodiment, the applicants may be individuals or business entities that are applying for funds.

In an embodiment of the invention, a business loan applicant may access a secured site, input information into a loan application and receive an automated, non-binding term sheet based on a parameter driven credit matrix and applicable loan product identifier. FIG. 2 shows the business process workflow, the users, and the application elements involved in the implementation of the apparatus and method.

In an embodiment of the invention shown in FIG. 2, a loan applicant (210) may connect to a loan application introduction page/screen (215), where the applicant may be presented with information regarding the application process. For example, the introduction pages/screens may explain the application process, time require to complete loan application, required information, required documentation and response time.

When an applicant connects to the underwriter's web site, the underwriter may display a screen requesting that the applicant enter his or her name, pseudonym, or the like, and password, which allows the applicant to interact with or “log-on” to the underwriter's web site. In an alternative embodiment, the applicant may not be required to enter a password. If the underwriter charges a fee for the computer application, the applicant may be connected to a financial network (not shown) to verify the applicant's ability to pay the fee. For example, an applicant may provide a bank account number to allow fees to be automatically deducted from their account. If the financial center rejects the applicant's ability to make payment, the system may be configured to deny services to the applicant.

An applicant may access the secured web site and enter preliminary personal data as well as a login name and password. This information may be used to identify the applicant throughout the process and may allow the applicant to leave the site and return to finish the application at a later time.

After providing the preliminary information, the applicant may enter information into a multiple screen loan application. This information may pertain to business information, sources and uses of the loan, credit decision information, and permission to access an applicant's personal credit history. At any time during the process, the applicant (borrower) may become ineligible for a loan from the lender as a result of information provided. For example, if the desired loan size is outside the range of lender's targets, the applicant may be informed and redirected to an appropriate lending partner. If an applicant decides to discontinue the application process, the applicant's information entered to that point may be saved in the lender's database. The application may be filtered out during the loan application or passed through to the credit matrix.

After the applicant completes the application forms (process), the information in the forms may be sent to a credit matrix application, which processes the information according to business logic retrieved from the lender's database. Additionally, personal credit history and reports may be accessed from third party credit reporting services such as Equifax and Experian. Based on the borrower's data and the personal credit report, the credit matrix may calculate an overall score as well as retain the measurements and scores for the individual indicators within each credit matrix category. For low scoring loans, the applicant may be notified that the lender may not be the “best-fit” for their financing needs and provided other possible avenues to pursue. All applicants'credit matrix scores may be stored in the lender's database.

Loan applications that meet certain credit criteria, may be passed to a loan product identifier. The loan product identifier applies the lender's loan product parameters, eligibility parameters, and business logic to identify loan products whose requirements are satisfied by a particular Loan Application. The Loan Product Identifier determines which loan applications are the loans that are “maybe” loans that require further investigation prior to or fit a loan bucket but score marginally.

For loans that may meet the lender criteria, the system may automatically generate a term sheet which may be presented to the applicant as a non-binding offer. The term sheet and supporting data may be stored on the database. For middle scoring and “maybe” loans, the applicant may be notified that a term sheet could not be created, but a Business Development Officer (BDO) may initiate contact within 24 hours in order to discuss the application. In both cases, the appropriate BDO may be informed of the application and may follow up and continue the loan application process.

The invention may be implemented in an advanced multi-tiered architecture built around JAVA technology. JAVA provides a requisite functionality, which minimizes the need to custom craft various aspects of the total solution. JAVA also serves as a widely accepted and well-implemented means to custom craft advanced web-based solutions.

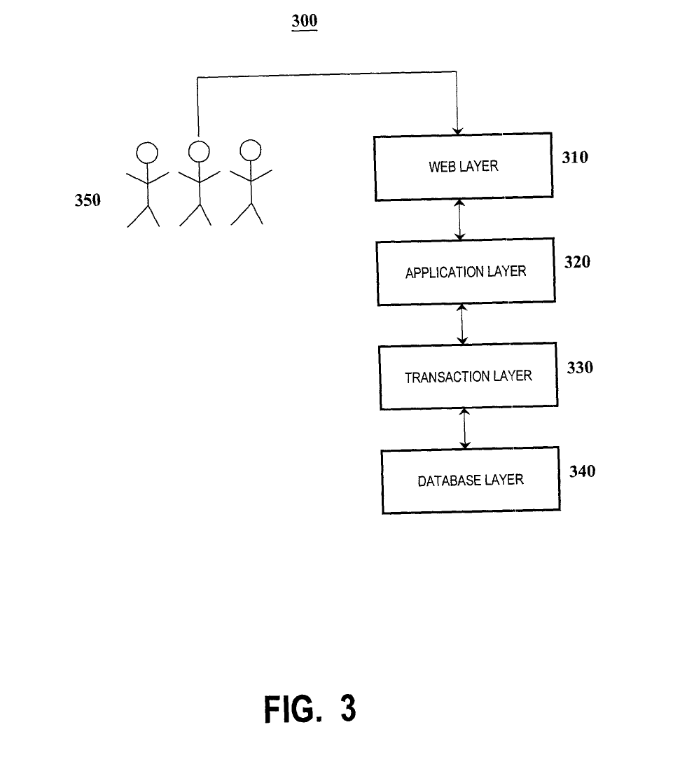

A four-tier architecture may be utilized in the construction of the apparatus as illustrated in FIG. 3. All external user (applicant) interactions occur at the web layer (Tier One). Once a user session is successfully established, all inputted information flows to the application and business logic layer (Tier Two). If the processing of the inputted information requires any additional data, a request may be made to the transaction layer (Tier Three). The transaction layer provides efficient connectivity in a secure manner with the database layer (Tier Four).

The present invention provides redundancy and reliability into all crucial areas of the lender's architecture. The lender's web facilities may operate on a Sun Solaris platform. An embodiment of the invention utilizes open standards, such as Java and XML/XSL to ensure extensibility and maintainability for the existing application as well as any applications that might be associated with it in the future. By adopting open standards, an underwriter may be positioned for utilizing emerging technology trends that are not yet standards, but show promise in future applications. The following technologies are examples that may be used in the online loan application process: JAVA, utilizing servlets, JDBC, RMI and objects (classes, interfaces, etc); Oracle database; DOM (Document Object Model); XML (extensible Markup Language); XSL (extensible Stylesheet Language); HTML (Hyper Text Markup Language).

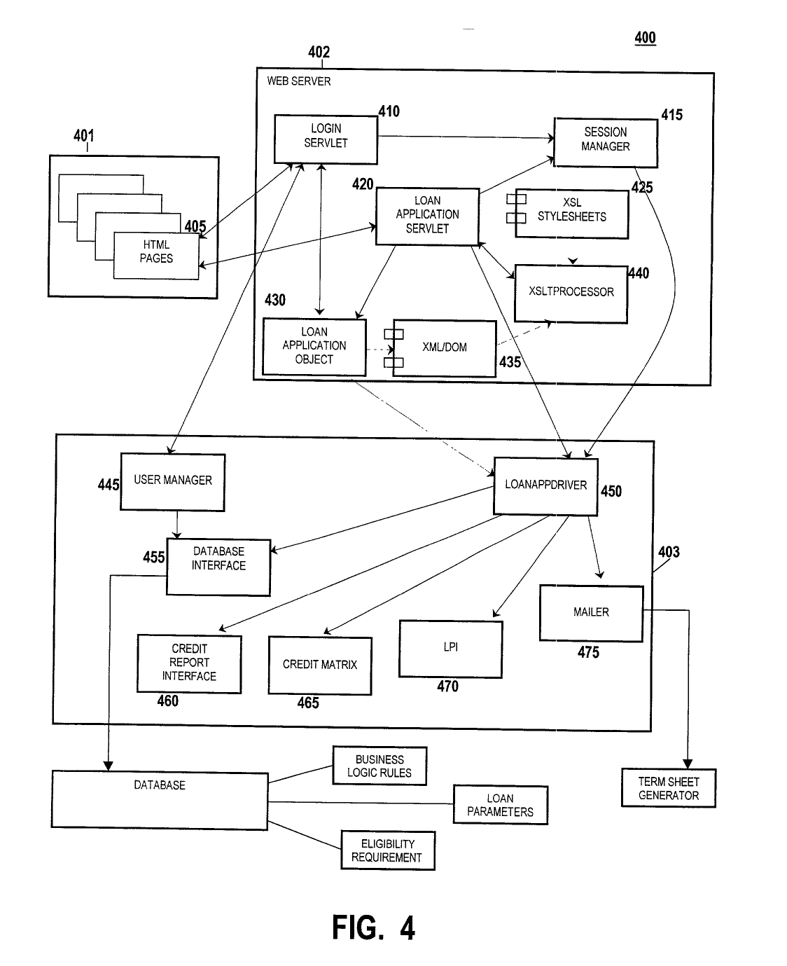

The overall application architecture may be described focusing on the Java objects and packages in FIGS. 4 & 5. By focusing on the diagrams, such as Deployment and Sequence Diagrams, the entire design is understood in a manner not achievable by programming code.

FIG. 4 demonstrates the application deployed on three platforms—the applicant's web browser (401), the Web Server (402), and the Application/Database Server (403). The loan applicant receives HTML pages on his browser from the Login servlet (410) or the LoanApplication servlet (420). When the applicant submits a page, the information may be returned to a servlet (410), which then stores loan application data in the LoanApplication Object (430). The objects on the web server are chiefly engaged with managing the users'sessions (SessionManager 415) and migrating the loan application pages (LoanApplication servlet (420), XML/DOM (435), XSL (425), and XSL Processor (440)). The LoanApplication object (430) resides on the web server to re-populate pages the applicant may choose to visit again (clicking the previous button) or when an applicant returns to an unfinished application.

When a new applicant visits the lender's site and creates a new user account, their information may be verified, stored in a database, and the first page of the loan application may be displayed. The request may be initially received by a login servlet(410), which may forward the request to the user manager. The user manager may check with the database to make sure the entered user id is not already in use. If the validation succeeds, the user manager may send the user's basic information (user logon information, and primary user information) to the database for storage. At this point, the user manager may return the newly created loan application back to the login servlet. The login servlet may then tell the user manager to login the new user. After the user is logged in, the login servlet requests the DOM from the loan application, and sends the DOM to the XSL processor for translation to HTML. The XSL processor returns the generated HTML to the client's web browser.

When a user attempts to login to the site, their userid and password are validated, their loan application information may be retrieved from the database, their session may be saved, and the first page of the loan application may be presented. The request may be initially received by the login servlet, which may forward the request to the user manager. The user manager may retrieve the user's logon information from the database and use that information to validate the entered userid and password. If the validation succeeds, the user manager may tell the loanappretrieval component to retrieve all of the user's data from the database. After all of the data has been retrieved, the user manager returns the newly created loan application back to the login servlet. The login servlet requests the DOM from the loan application, and sends the DOM to the XSL processor for translation to HTML. The XSL processor returns the generated HTML to the client's web browser.

When a user submits a change page request (by clicking on either the ‘previous’ or ‘continue’ buttons located at the bottom of every page), the information they have entered on the current page may be stored in memory, and the new page may be generated and displayed. The request may be retrieved by the loan application servlet, including all parameters from the current page. The LoanApplicationServlet passes the page parameters to the loan application for storage. Then the servlet requests the DOM from the loan application, and sends the DOM to the XSL processor for translation to HTML. The XSL processor returns the generated HTML to the client's web browser.

When a user submits an application, the application may be saved, all credit decisions are made, and the result may be displayed to the user. The LoanApplicationServlet (420) receives the initial request. The servlet passes all of the parameters from the current page to the loan application (430) for storage. The servlet then passes the loan application to the LoanAppDriver (450) for processing. The LoanAppDriver first saves the loan application to the database (455).

After saving, the loan application may be prepared for processing by calculating user values for all indicators, determining SBA eligibility, and retrieving Experian credit reports (460) for all owners. Once the loan application is prepared, the credit decision may be made. The application first passes through the credit matrix to receive a credit score. An initial decision may be made based on the credit score. If the credit score passes the initial decision, the application passes through the loan product identifier (470) to determine any loan types for which this application qualifies. Once all processing has occurred, the loan application may be returned to the loan application servlet (including the results of all processing). After returning the result to the loan application servlet, the LoanAppDriver sends an e-mail to the assigned BDO with the results of the application. The servlet then generates the appropriate result page (a termsheet, a denial, or a message indicating that the user may be contacted by a BDO) and displays the results to the user.

In an embodiment of the invention, all servers may be placed at a remote datacenter to provide the highest availability. UUNET datacenter is an example of a remote datacenter that may be equipped to provide all infrastructure support.

In order to provide real-time access to multiple consumer credit reports or other third party data, one or more communication links may be established between the system and an external data source, such as, for example a source of consumer or commercial credit information.

The remote database may contain default constants that represent variables with a given value that remains static throughout the online loan origination process. These values may be determined by underwriter according to credit policies, market fluctuations, and Small Business Administration guidelines.

The online loan application pages may be displayed leveraging XML (extensible Markup Language), XSL (eXtensible Stylesheet Language), DOM (Document Object Model), JavaScript, HTML (Hyper Text Markup Language), and Java servlets. An XSL stylesheet may specify the presentation of XML documents by describing how particular data in a XML document may be displayed in a browser. A XSL processor combines a XML tree with a particular stylesheet to generate the HTML page that may be viewed by the user.

The credit matrix may be utilized to generate a numerical score that may subsequently used to make credit a decision. The numerical score may be based on accumulating component scores from cateogries (or columns) within the matrix. The following variables are examples which may be utilized to establish a score and identify an appropriate loan product: Credit History Response; Third Party Credit Scores; Liquid value of Commercial Real Estate; Residential Real Estate; Machinery & Equipment; Collateral, Construction cost; Loan Amount; Equity; Project Cost; SBA Loan Amount; Management; Experience; Company Sales and Affiliate Sales.

In order to be a potential candidate for a loan, the application must score over a threshold established for a particular product. Score indicators may be stored in a database and retrieved to use with loan identifier application.

The credit matrix may be divided into multiple categories, such as, repayment ability, collateral, management experience, personal credit history, leverage & equity, and working capital. A range of scores may be associated with each category. Table 1 represents an example of a matrix. Each equation may advantageously define a range based on application and lender specific algorithms. The component score value may be based on which range the loan application data falls in. The component scores may be accumulated on a weighted or unweighted basis in order to arrive at an overall credit score.

TABLE 1

| | | | | | | Working |
|---|---|---|---|---|---|---|
| | Repayment | | Management | Personal Credit | | Capital |
| Score | Ability | Collateral | Experience | History | Leverage & Equity | Availability |
| 5 | Repayment | Collateral | Management | Personal Credit | Leverage & Equity | Working |
| | Equation 5 | Equation 5 | Experience | History | Equation 5 | Capital |
| | | | Equation 5 | Equation 5 | | Availability |
| | | | | | | Equation 5 |
| 4 | Repayment | Collateral | Management | Personal Credit | Leverage & Equity | Working |
| | Equation 4 | Equation 4 | Experience | History | Equation 4 | Capital |
| | | | Equation 4 | Equation 4 | | Availability |
| | | | | | | Equation 4 |
| 3 | Repayment | Collateral | Management | Personal Credit | Leverage & Equity | Working |
| | Equation 3 | Equation 3 | Experience | History | Equation 3 | Capital |
| | | | Equation 3 | Equation 3 | | Availability |
| | | | | | | Equation 3 |
| 2 | Repayment | Collateral | Management | Personal Credit | Leverage & Equity | Working |
| | Equation 2 | Equation 2 | Experience | History | Equation 2 | Capital |
| | | | Equation 2 | Equation 2 | | Availability |
| | | | | | | Equation 2 |
| 1 | Repayment | Collateral | Management | Personal Credit | Leverage & Equity | Working |
| | Equation 1 | Equation 1 | Experience | History | Equation 1 | Capital |
| | | | Equation 1 | Equation 1 | | Availability |
| | | | | | | Equation 1 |

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

We claim:

1. An automated loan application processing system comprising:
a credit scoring computer module whose actions are directed by software components wherein the credit scoring computer module includes a credit matrix which calculates an overall score on the basis of data representative of a particular loan application and business logic rules for a plurality of credit matrix categories; and
a loan product identifier responsive to said overall score, a loan product parameters, eligibility parameters, and business logic rules to identify a loan product whose requirements are satisfied by a particular loan application.

2. An automated loan application processing system, according to claim 1, further comprising:
a database, communicating with said credit scoring computer module and said loan product identifier, containing said business logic rules, said loan product parameters, and said eligibility parameters.

3. An automated loan application processing system, according to claim 1, further comprising:
a web based applicant interface communicating with said database for collecting applicant information.

4. An automated loan application processing system, according to claim 1, further comprising:
an automated query interface communicating with said database for collecting external credit information.

5. An automated loan application processing system, according to claim 1, further comprising a term sheet generator.

6. An automated loan application processing system, according to claim 1, further comprising:
a web based business development officer interface communicating with said database for reviewing applicant information.

7. An automated loan application processing system, according to claim 4, wherein said external credit information is credit history report form a third party source.

8. An automated loan application processing system, according to claim 1, wherein said business logic rules include at least one of the following parameters: repayment ability, collateral, management experience, personal credit history, leverage & equity, and working capital.

9. An automated loan application processing system, according to claim 1, wherein said eligibility parameters include Small Business Administration loan eligibility requirements.

10. An automated loan application processing system, according to claim 1, wherein said credit matrix is divided into multiple categories, such as, repayment ability, collateral, management experience, personal credit history, leverage & equity, and working capital.

11. A method for automating a loan application process comprising the steps of:
generating a credit score based on data representative of a loan application and business logic rules; and
determining a loan product available to an applicant using said credit score, lender loan product parameters, eligibility requirements.

12. A method for automating a loan application process according to claim 11, wherein said credit score is calculated by generating an overall score for a plurality individual variables within a credit matrix.

13. A method for implementing an on-line underwriting system through a communications network comprising the steps of:
collecting applicant information relating to a loan application;
generating a credit score based on data representative of the loan application and business logic rules; and
determining a loan product available to an applicant using said credit score, lender loan product parameters, eligibility requirements
generating a term sheet for an applicant relating to the product and terms of an identified loan product.
